(19) United States
(12) Patent Application Publication
(10) Pub. No.: US 2020/0135104 A1
(43) Pub. Date: Apr. 30, 2020

(54) PIXEL DRIVING CIRCUIT AND OLED DISPLAY APPARATUS

(71) Applicant: Wuhan China Star Optoelectronics Semiconductor Display Technology Co., Ltd., Wuhan, Hubei (CN)

(72) Inventors: Xueshun HOU, Wuhan, Hubei (CN); Guang LI, Wuhan, Hubei (CN)

(21) Appl. No.: 15/754,050

(22) PCT Filed: Jan. 27, 2018
(86) PCT No.: PCT/CN2018/074371

§ 371 Date: Feb. 21, 2018

(30) Foreign Application Priority Data
Dec. 20, 2017 (CN) 201711383331.8

(51) Int. Cl. G09G 3/3258; G09G 3/3266; G09G 3/3291

(52) U.S. Cl. CPC G09G 3/3258; G09G 2310/0216; G09G 3/3291; G09G 3/3266

(57) ABSTRACT

A pixel driving circuit and organic light-emitting diode (OLED) display apparatus having the pixel driving circuit is provided. The pixel driving circuit with 6T1C pixel structure effectively compensates the threshold voltage of the driving transistor, which drives the OLED display apparatus, to prevent the current flows through the OLED from being correlated with the threshold voltage of the driving transistor, so that the poor display image caused due to the threshold voltage shifting of the driving transistor is eliminated.

### RELATED APPLICATIONS

The present application is a National Phase of International Application Number PCT/CN2018/074371, filed Jan. 27, 2018, and claims the priority of China Application No. 201711383331.8, filed Dec. 20, 2017.

### FIELD OF THE DISCLOSURE

The disclosure relates to an organic electroluminescence technical field, and more particularly to a pixel driving circuit and organic light-emitting diode (OLED) display apparatus.

### BACKGROUND

In recent years, Organic Light-Emitting Diode (OLED) displays have become very popular emerging flat panel display products at home and abroad because OLED displays have the characteristics of self-luminous, wide viewing angle, short reaction time, high luminous efficiency, low operating voltage, thin thickness, being manufactured as large size and flexible displays, simple process and potential of low cost.

In OLED displays, transistors (TFT's) are often used in conjunction with capacitor storage signals to control the luminance grey scale of an OLED. In order to achieve the purpose of constant current driving, at least two TFT's and one storage capacitor is necessary for forming each pixel, that is, 2T1C mode. FIG. 1 is a circuit diagram of a pixel driving circuit of an existed OLED display. Referring to FIG. 1, a pixel of the existed OLED display includes two TFT's and one capacitor, specifically, a switching TFT T1, a driving TFT T2, and a storage capacitor Cst. The driving current of the OLED is controlled by the driving TFT T2 and a value of the driving current is: I_{OLED}=k(V_{gs}−Vₜₕ)², wherein k is the intrinsic conduction factor of the driving TFT T2 and is determined by the characteristics of the driving TFT T2 itself, Vₜₕ is the threshold voltage of the driving TFT T2, V_{gs} is the difference between the gate electrode of the driving TFT T2 and the first electrode of the driving TFT T2. Due to the long time operation, the threshold voltage Vₜₕ of the driving TFT T2 may be shifted so that the driving current of the OLED is changed accordingly to make poor display of the OLED display and affect the quality of displayed images.

### SUMMARY

In order to solve the problems of the existed technology, one of the objects of the present disclosure is to provide a pixel driving circuit capable of preventing the driving current of an organic light-emitting diode (OLED) from being affected by the threshold voltage of the driving transistor, and an OLED display apparatus having the pixel driving circuit.

In accordance with one aspect of the disclosure, a pixel driving circuit is provided to comprise a reset module, a threshold voltage compensate module, a light-emitting drive module and an OLED. The reset module is configured to receive a reset signal from a reset signal line and a reference voltage signal from a reference voltage line in a reset stage and generate a potential reset signal in accordance with the reset signal and the reference voltage signal. The light-emitting drive module is configured to receive the potential reset signal and perform a potential reset operation in accordance with the received potential reset signal in the reset stage. The threshold voltage compensate module configured to receive a scan signal from a scan line and a data signal from a data line in a threshold voltage compensate stage and generate a threshold voltage compensate signal in accordance with a scan signal and the data signal. The light-emitting drive module is configured to receive the threshold voltage compensate signal and perform a threshold voltage compensate operation in accordance with the received threshold voltage compensate signal in the threshold voltage compensate stage. The light-emitting drive module is configured to receive an enable signal from an enable signal line and a power voltage signal from a power line in a light-emitting drive stage and generate a light-emitting drive signal in accordance with the enable signal and the power voltage signal. The OLED is configured to receive the light-emitting drive signal and emit light in accordance with the light-emitting drive signal.

In one embodiment, the reset signal is kept at low potential in the reset stage; the reset signal is kept at low potential for a predetermined time period and changed to high potential from low potential after the predetermined time period in the threshold voltage compensate stage; and the reset signal is kept at high potential in the light-emitting drive stage; the enable signal is kept at high potential in the reset stage and the threshold voltage compensate stage, and is kept at low potential in the light-emitting drive stage; and the scan signal is kept at high potential in the reset stage, kept at low potential in the threshold voltage compensate stage, and kept at high potential in the light-emitting drive stage.

In one embodiment, the reset module comprises a fourth transistor; a gate electrode of the fourth transistor is connected to the reset signal line to receive the reset signal; a first electrode of the fourth transistor is connected to the reference voltage line to receive the reference voltage signal; and a second electrode of the fourth transistor is connected to a first node.

In one embodiment, the fourth transistor is configured to be conducted in the reset stage; the fourth transistor is configured to be conducted within the predetermined time period and terminated after the predetermined time period in the threshold voltage compensate stage; and the fourth transistor is configured to be terminated in the light-emitting drive stage.

In one embodiment, the threshold voltage compensate module comprises a second transistor, a third transistor and a capacitor. A gate electrode of the second transistor is connected to the scan line to receive the scan signal; a first electrode of the second transistor is connected to the data line to receive the data signal; and a second electrode of the second transistor is connected to a first terminal of the capacitor; a gate electrode of the third transistor is connected to the scan line to receive the scan signal; a first electrode of the third transistor is connected to the first node; and a second electrode of the third transistor is connected to a third node; and a second terminal of the capacitor is connected to the first node.

In one embodiment, the second transistor and the third transistor are configured to be terminated in the reset stage; the second transistor and the third transistor are configured to be conducted in the threshold voltage compensate stage; and the second transistor and the third transistor are configured to be terminated in the light-emitting drive stage.

In one embodiment, the light-emitting drive module comprises a first transistor, a fifth transistor and a sixth transistor. A gate electrode of the first transistor is connected to the first node, a first electrode of the first transistor is connected to a second node, the power line is connected to the second node, and a second electrode of the first transistor is connected to the third node; a gate electrode of the fifth transistor is connected to the enable signal line to receive the enable signal; a first electrode of the fifth transistor is connected to the second node; and a second electrode of the fifth transistor is connected to the first terminal of the capacitor, a gate electrode of the sixth transistor is connected to the enable signal line to receive the enable signal; a first electrode of the sixth transistor is connected to the third node; and a second electrode of the sixth transistor is connected to the OLED.

In one embodiment, the first transistor is configured to be terminated in the reset stage, conducted in the threshold voltage compensate stage, and conducted in the light-emitting drive stage; and the fifth transistor and the sixth transistor are configured to be terminated in the reset stage; terminated in the threshold voltage compensate stage, and conducted in the light-emitting drive stage.

In one embodiment, each of the first to sixth transistors is a p channel transistor.

In accordance with another aspect of the disclosure, an OLED display apparatus is provided to comprise the pixel driving circuit described above.

The beneficial effect of the disclosure are as follows: the pixel driving circuit with 6T1C pixel structure in the disclosure effectively compensates the threshold voltage of the driving transistor, which drives the OLED display apparatus, to prevent the current flows through the OLED from being correlated with the threshold voltage of the driving transistor, so that the poor display image caused due to the threshold voltage shifting of the driving transistor is eliminated.

### BRIEF DESCRIPTION OF THE DRAWINGS

Features and advantages in above and other aspects of the embodiments of the present disclosure could be clearer through the descriptions made below accompanying with the drawings. In the drawings:

FIG. 1 is a circuit diagram of a pixel driving circuit of an existed OLED display apparatus;

FIG. 2 is a structural diagram of the OLED display apparatus according to one embodiment of the present disclosure;

FIG. 3 is a module diagram of the pixel driving circuit according to one embodiment of the present disclosure;

FIG. 4 is a timing diagram of the signals according to one embodiment of the present disclosure;

FIG. 5 is a circuit diagram of the pixel driving circuit according to one embodiment of the present disclosure; and

FIG. 6A to FIG. 6C are schematic diagrams showing operations of the pixel driving circuit according to one embodiment of the present disclosure.

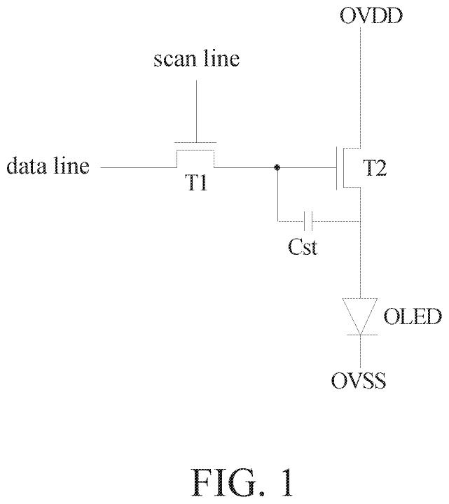

### DETAILED DESCRIPTION OF PREFERRED EMBODIMENTS

The embodiments of the present disclosure are described in detail with reference to the drawings. However, the invention may be embodied in many different forms and should not be construed as limited to the specific embodiments set forth herein. Rather, these embodiments are provided to explain the principles of the disclosure and its practical application to thereby enable those of ordinary skill in the art to understand various embodiments of the disclosure and various modifications suited to particular usages.

In the drawings, the thickness of layers and regions is exaggerated for clarity. The same reference numbers indicate the same components throughout the specification and the drawings.

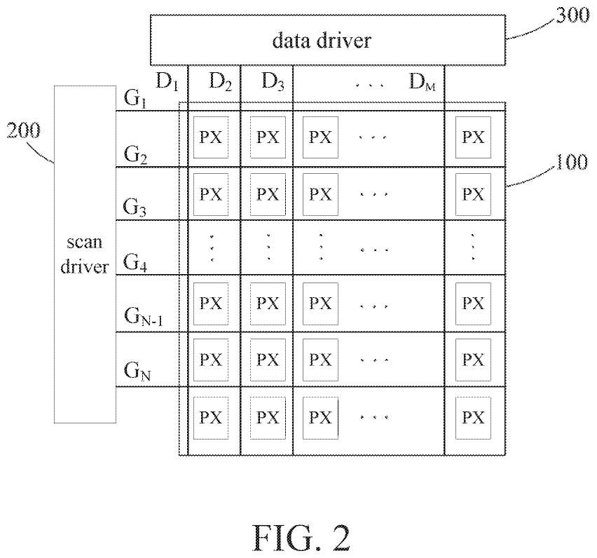

FIG. 2 is a structural diagram of the organic light-emitting diode (OLED) display apparatus according to one embodiment of the present disclosure.

Referring to FIG. 2, the OLED display apparatus according to the present disclosure comprises: a display panel 100, a scan driver 200 and a data driver 300. It is noted that the OLED display apparatus according to the present disclosure may further comprise other components necessary, such as a timing controller for controlling the scan driver 200 and the data driver 300, a power voltage generator for providing a power positive voltage signal and a power negative voltage signal, an enable signal generator for providing an enable signal, a reference voltage generator for providing a reference voltage signal, etc.

Specifically, the display panel 100 comprises: a plurality of pixels PX arranged in array, N scan lines G₁˜G_{N}, and M data lines D₁˜D_{M}. The scan driver 200 is connected to and drives the scan lines G₁˜G_{N}. The data driver 300 is connected to and drives the data lines D₁˜D_{M}.

The scan driver 200 provides one or more scan signals to each pixel PX and will be described below. The data driver 300 provides data signals to each pixel PX and will be described below, as well.

Each pixel PX comprises a pixel driving circuit. The pixel driving circuit (i.e., the pixel structure of the pixel PX) is described in detail below in accordance with the embodiments of the present disclosure.

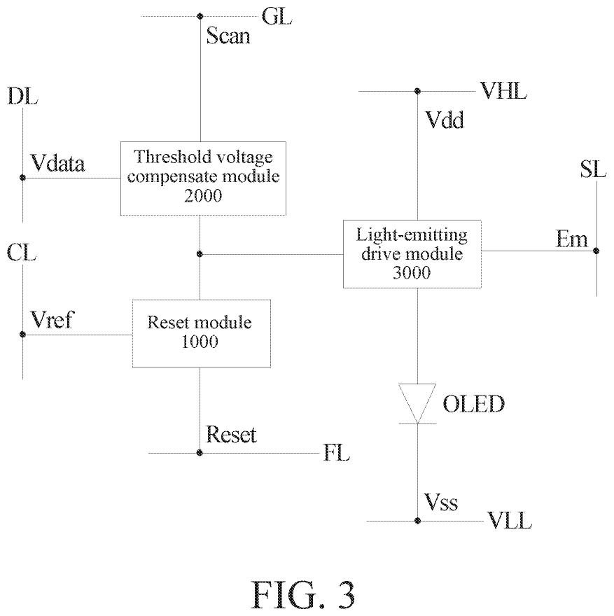

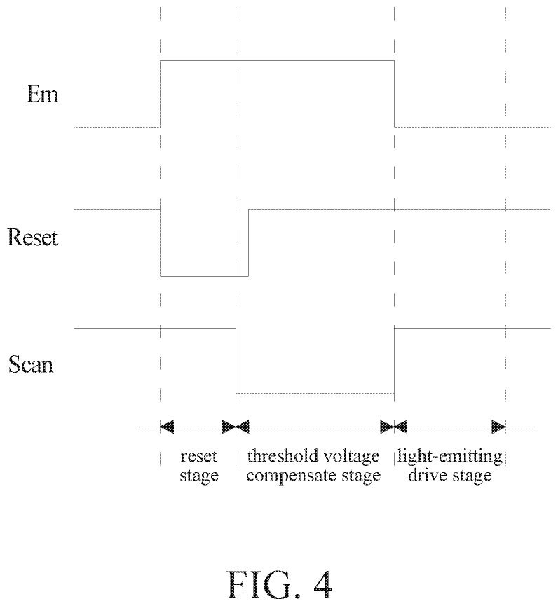

FIG. 3 is a module diagram of the pixel driving circuit according to one embodiment of the present disclosure. FIG. 4 is a timing diagram of the signals according to one embodiment of the present disclosure.

Referring to FIG. 3, the pixel driving circuit of the OLED display apparatus according to one embodiment of the present disclosure comprises a reset module 1000, a threshold voltage compensate module 2000, a light-emitting module 3000 and an OLED.

Referring to FIG. 3 and FIG. 4 together, the reset module 1000 is connected to the reference voltage line CL and the reset signal line FL, respectively. The threshold voltage compensate module 2000 is connected to the scan line GL (which is one of the scan lines G₁˜G_{N}) and the data line DL (which is one of the data lines D₁˜D_{M}), respectively. The light-emitting drive module 3000 is connected to the enable signal line SL and the first power line VHL, respectively. The reset module 1000 is connected to the threshold voltage compensate module 2000, the light-emitting module 3000 is connected at a node between the reset module 1000 and the threshold voltage compensate module 2000. The OLED is connected to the light-emitting drive module 3000.

The reset module 1000 is used for receiving the reset signal Reset from the reset signal line FL and the reference voltage signal Vref from the reference voltage line CL in a reset stage, and generating a potential reset signal in accordance with the received reset signal Reset and reference voltage signal Vref. The light-emitting drive module 3000 is used for receiving the potential reset signal and performing a potential reset operation in accordance with the received potential reset signal in the reset stage.

The threshold voltage compensate module 2000 is used for receiving the scan signal Scan from the scan line GL and the data signal Vdata from the data line DL in the threshold voltage compensate stage, and generating a threshold voltage compensate signal in accordance with the received scan signal Scan and data signal Vdata. The light-emitting drive module 3000 is used for receiving the threshold voltage compensate signal and performing a threshold voltage compensate operation in the threshold voltage compensate stage.

The light-emitting drive module 3000 is used for receiving the enable signal EM from the enable signal line SL and the power voltage signal Vdd from the first power line VHL in a light-emitting drive stage, and generating a light-emitting drive signal in accordance with the received enable signal Em and power voltage signal Vdd. The OLED is used for receiving the light-emitting drive signal and emitting light in accordance with the received light-emitting drive signal. The power voltage signal Vdd is at high potential herein.

In one embodiment, the anode of the OLED is connected to the light-emitting drive module 3000, and the cathode of the OLED is connected to the second power line VLL to receive the power voltage signal Vss at low potential from the second power line VLL.

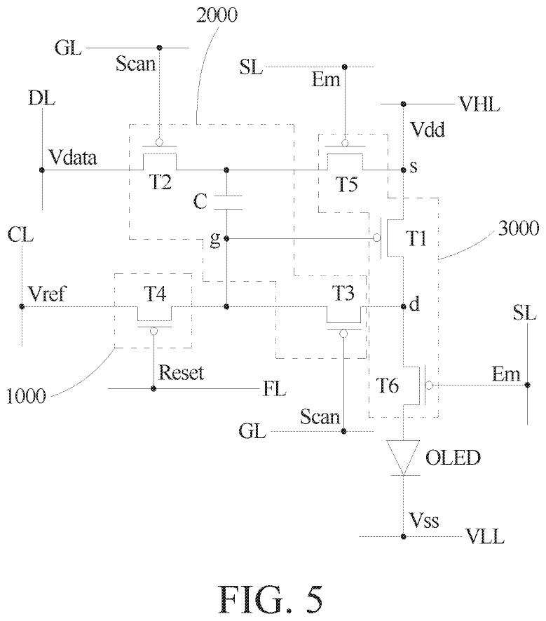

The specific circuit structures adopted for the modules described above will be described in detail below. FIG. 5 is a circuit diagram of the pixel driving circuit according to one embodiment of the present disclosure.

Referring to FIG. 5, the pixel driving circuit according to one embodiment of the present disclosure has a 6T1C pixel structure.

Specifically, the reset module 1000 comprises the fourth transistor T4. The gate electrode of the fourth transistor T4 is connected to the reset signal line FL to receive the reset signal Reset; the first electrode of the fourth transistor T4 is connected to the reference voltage line CL to receive the reference voltage signal Vref; and the second electrode of the fourth transistor T4 is connected to the first node g. In the embodiment, the reference voltage signal Vref is at low potential and the voltage of the reference voltage signal can be set as −3V˜−2V, however, the present invention is not limited to these parameters.

The threshold voltage compensate module 2000 comprises the second transistor T2, the third transistor T3 and the capacitor C. The gate electrode of the second transistor T2 is connected to the scan line GL to receive the scan signal Scan; the first electrode of the second transistor T2 is connected to the data line to receive the data signal Vdata; and the second electrode of the second transistor T2 is connected to the first terminal of the capacitor C. The gate electrode of the third transistor T3 is connected to the scan line GL to receive the scan signal Scan; the first electrode of the third transistor T3 is connected to the first node g; and the second electrode of the third transistor T3 is connected to the third node d. The second terminal of the capacitor C is connected to the first node g. In the present embodiment, the data signal Vdata is at high potential and the voltage of the data signal can be set as to 2V˜6V, however, the present invention is not limited to these parameters.

The light-emitting drive module 300 comprises the first transistor T1, the fifth transistor T5 and the sixth transistor T6. The gate terminal of the first transistor T1 is connected to the first node g, the first electrode of the first transistor T1 is connected to the second node s, and the second electrode of the first transistor T1 is connected to the third node d. The first power line VHL is connected to the second node s to provide the power voltage signal Vdd which is at high potential to the second node s. The gate electrode of the fifth transistor T5 is connected to the enable signal line SL to receive the enable signal Em, the first electrode of the fifth transistor T5 is connected to the second node s, and the second electrode of the fifth transistor T5 is connected to the first terminal of the capacitor C. The gate electrode of the sixth transistor T6 is connected to the enable signal line SL to receive the enable signal Em, the first electrode of the sixth transistor T6 is connected to the third node d, and the second electrode of the sixth transistor T6 is connected to the OLED. Specifically, the second electrode of the sixth transistor T6 is connected to the anode of the OLED. In the present embodiment, the power voltage signal Vdd is at high potential and the voltage of the power voltage signal Vdd could be 1V˜2V, and the power voltage signal Vss is at low potential and the voltage of the power voltage signal Vss could be −6V˜−5V, however, the present invention is not limited to these parameters.

In this embodiment, each of the first electrodes of the first to sixth transistors (T1˜T6) could be the source electrode or the drain electrode, and each of the second electrodes of the first to sixth transistors (T1˜T6) could be the electrode different from the first electrode.

For example, the second electrode is the source electrode when the first electrode is the drain electrode, and the second electrode is the drain electrode when the first electrode is the source electrode.

Each of the first to sixth transistors (T1˜T6) can be with the same channel type.

For example, each of the first to sixth transistors (T1˜T6) can be a p channel transistor.

Therefore, each of the first to sixth transistors (T1˜T6) can be realized by using polysilicon thin film transistor, amorphous silicon thin film transistor or oxide thin film transistor.

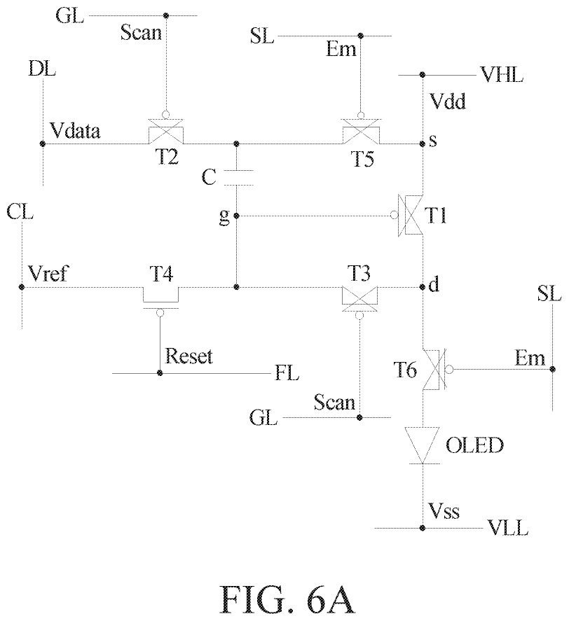

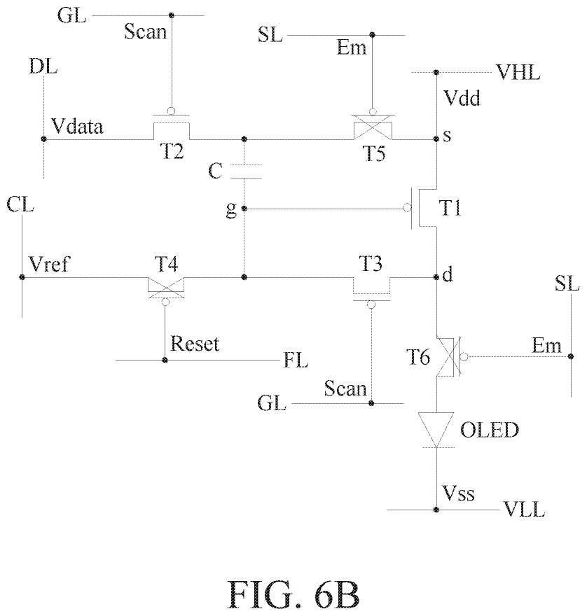

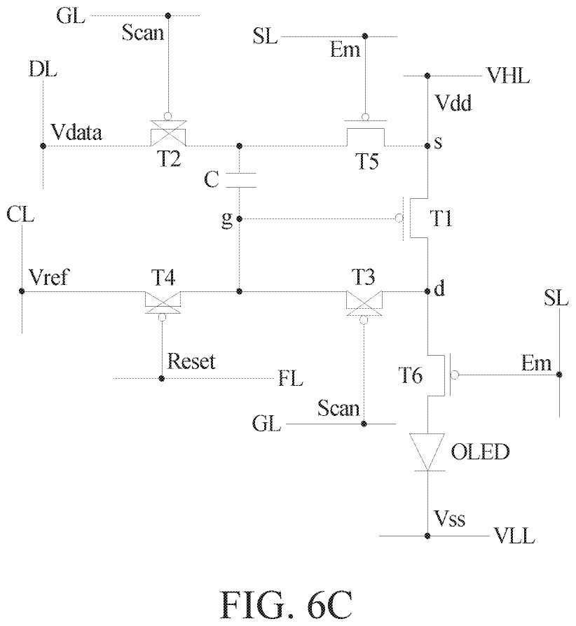

The operation principles of the pixel driving circuit according to the embodiment of the present invention will be described in detail below. In the present embodiment, the pixel driving circuit according to the embodiment of the present invention adopts the 6T1C pixel structure and performs sequentially the reset operation (i.e., is in the reset stage), the threshold voltage compensate operation (i.e., is in the threshold compensate stage), and the light-emitting drive operation (i.e., in the light-emitting drive stage). FIG. 6A to FIG. 6C are schematic diagrams showing operations of the pixel driving circuit according to one embodiment of the present disclosure. In the FIG. 6A to FIG. 6C, the cross symbol (X) on a transistor represents that the transistor is terminated, and the transistor is conducted when there is no cross symbol (X) shown on the transistor.

First, in the reset stage, referring to FIG. 4 and FIG. 6A, the reset signal Reset is kept at low potential, and the scan signal Scan and the enable signal Em are kept at high potential. At this time, the fourth transistor T4 is conducted, and the second transistor T2, the third transistor T3, the fifth transistor T5 and the sixth transistor T6 are terminated. The conducted fourth transistor T4 provides the reference voltage signal Vref to the gate electrode of the first transistor T1 so that the gate terminal of the first transistor T1 is reset to the reference voltage signal Vref at low potential. Because the voltage of the reference voltage signal Vref is not enough to turn on the first transistor T1, the first transistor T1 is still terminated.

In the threshold voltage compensate stage, the scan signal Scan is at low potential, the enable signal Em is at high potential, and the reset signal Reset is firstly kept at low potential for a predetermined time period and then changed to be at high potential after the predetermined time period. That is, after entering into the threshold voltage compensate stage, the reset signal Reset and the scan signal Scan are kept at low potential in the predetermined time period, and, after the predetermined time period is passed, the scan signal Scan is still kept at low potential while the reset signal Reset is kept at high potential. At this time, the fourth transistor T4 is conducted in the predetermined time period and terminated after the predetermined time period, the second transistor T2 and the third transistor T3 are conducted and the fifth transistor T5 and the sixth transistor T6 are terminated, so that the data signal Vdata is stored in the capacitor C. Because the reset signal Reset is kept at low potential in the predetermined time period in the beginning and then changed to be at high potential from low potential after the predetermined time period, the gate electrode of the first transistor T1 would not be coupled to be an extreme high voltage. When the threshold voltage compensate stage is ended, the voltage Vg of the gate electrode of the first transistor T1 is Vg=Vdd+Vth and the first transistor T1 is conducted, wherein Vth is the threshold voltage of the first transistor T1.

In the light-emitting drive stage, the reset signal Reset is kept at high potential, the scan signal Scan is kept at high potential, and the enable signal Em is kept at low potential. At this time, the fifth transistor T5 and the sixth transistor T6 are conducted, and the second transistor T2, the third transistor T3 and the fourth transistor T4 are terminated. The capacitor C couples the voltage (Vdd−Vdata) to the gate electrode of the first transistor T1 so that the voltage Vg of the gate electrode of the first transistor T1 is Vg=2Vdd−Vdata+Vth and the first transistor T1 is conducted. The voltage difference between the first node g and the second node s is Vg−Vs=2Vdd−Vdata+Vth−Vdd=Vdd−Vdata+Vth.

Therefore, the current I flows through the OLED can be represented as:

I=k(Vgs−Vth)²=k(Vdd+Vth−Vdata−Vth)²=k(Vdd−Vdata)²

Wherein, k is the intrinsic conduction factor of the first transistor T1 and is determined by the characteristics of the first transistor T1 itself.

Therefore, in the formula representing the current I flowing through the OLED, the current I is not related to the threshold voltage Vth of the first transistor T1, so that the poor display image caused due to the threshold voltage Vth shifting of the first transistor T1 is eliminated.

In summary, according to the embodiments of the disclosure, the current flowing through the OLED is not related to the threshold voltage of the driving transistor, so that the poor display image caused due to the threshold voltage shifting of the driving transistor could be eliminated.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. A pixel driving circuit, comprising:
a reset module configured to receive a reset signal from a reset signal line and a reference voltage signal from a reference voltage line in a reset stage, and generate a potential reset signal in accordance with the reset signal and the reference voltage signal;
a threshold voltage compensate module configured to receive a scan signal from a scan line and a data signal from a data line in a threshold voltage compensate stage, and generate a threshold voltage compensate signal in accordance with a scan signal and the data signal;
a light-emitting drive module configured to receive the potential reset signal and perform a potential reset operation in accordance with the received potential reset signal in the reset stage, receive the threshold voltage compensate signal and perform a threshold voltage compensate operation in accordance with the received threshold voltage compensate signal in the threshold voltage compensate stage, receive an enable signal from an enable signal line and a power voltage signal from a power line in a light-emitting drive stage, and generate a light-emitting drive signal in accordance with the enable signal and the power voltage signal; and
an organic light-emitting diode (OLED) configured to receive the light-emitting drive signal and emit light in accordance with the light-emitting drive signal.

2. The pixel driving circuit according to claim 1, wherein the reset signal is kept at low potential in the reset stage; the reset signal is kept at low potential for a predetermined time period and changed to high potential from low potential after the predetermined time period in the threshold voltage compensate stage; and the reset signal is kept at high potential in the light-emitting drive stage;
the enable signal is kept at high potential in the reset stage and the threshold voltage compensate stage, and is kept at low potential in the light-emitting drive stage;
the scan signal is kept at high potential in the reset stage, kept at low potential in the threshold voltage compensate stage, and kept at high potential in the light-emitting drive stage.

3. The pixel driving circuit according to claim 1, wherein the reset module comprises a fourth transistor;
a gate electrode of the fourth transistor is connected to the reset signal line to receive the reset signal; a first electrode of the fourth transistor is connected to the reference voltage line to receive the reference voltage signal; and a second electrode of the fourth transistor is connected to a first node.

4. The pixel driving circuit according to claim 2, wherein the reset module comprises a fourth transistor;
a gate electrode of the fourth transistor is connected to the reset signal line to receive the reset signal; a first electrode of the fourth transistor is connected to the reference voltage line to receive the reference voltage signal; and a second electrode of the fourth transistor is connected to a first node.

5. The pixel driving circuit according to claim 3, wherein the fourth transistor is configured to be conducted in the reset stage; the fourth transistor is configured to be conducted within the predetermined time period and terminated after the predetermined time period in the threshold voltage compensate stage; and the fourth transistor is configured to be terminated in the light-emitting drive stage.

6. The pixel driving circuit according to claim 4, wherein the fourth transistor is configured to be conducted in the reset stage; the fourth transistor is configured to be conducted within the predetermined time period and terminated after the predetermined time period in the threshold voltage compensate stage; and the fourth transistor is configured to be terminated in the light-emitting drive stage.

7. The pixel driving circuit according to claim 3, wherein the threshold voltage compensate module comprises a second transistor, a third transistor and a capacitor;
a gate electrode of the second transistor is connected to the scan line to receive the scan signal; a first electrode of the second transistor is connected to the data line to receive the data signal; and a second electrode of the second transistor is connected to a first terminal of the capacitor,
a gate electrode of the third transistor is connected to the scan line to receive the scan signal; a first electrode of the third transistor is connected to the first node; and a second electrode of the third transistor is connected to a third node;
a second terminal of the capacitor is connected to the first node.

8. The pixel driving circuit according to claim 4, wherein the threshold voltage compensate module comprises a second transistor, a third transistor and a capacitor;
a gate electrode of the second transistor is connected to the scan line to receive the scan signal; a first electrode of the second transistor is connected to the data line to receive the data signal; and a second electrode of the second transistor is connected to a first terminal of the capacitor,
a gate electrode of the third transistor is connected to the scan line to receive the scan signal; a first electrode of the third transistor is connected to the first node; and a second electrode of the third transistor is connected to a third node;
a second terminal of the capacitor is connected to the first node.

9. The pixel driving circuit according to claim 7, wherein the second transistor and the third transistor are configured to be terminated in the reset stage; the second transistor and the third transistor are configured to be conducted in the threshold voltage compensate stage; and the second transistor and the third transistor are configured to be terminated in the light-emitting drive stage.

10. The pixel driving circuit according to claim 8, wherein the second transistor and the third transistor are configured to be terminated in the reset stage; the second transistor and the third transistor are configured to be conducted in the threshold voltage compensate stage; and the second transistor and the third transistor are configured to be terminated in the light-emitting drive stage.

11. The pixel driving circuit according to claim 7, wherein the light-emitting drive module comprises a first transistor, a fifth transistor and a sixth transistor;
a gate electrode of the first transistor is connected to the first node, a first electrode of the first transistor is connected to a second node, the power line is connected to the second node, and a second electrode of the first transistor is connected to the third node;
a gate electrode of the fifth transistor is connected to the enable signal line to receive the enable signal; a first electrode of the fifth transistor is connected to the second node; and a second electrode of the fifth transistor is connected to the first terminal of the capacitor;
a gate electrode of the sixth transistor is connected to the enable signal line to receive the enable signal; a first electrode of the sixth transistor is connected to the third node; and a second electrode of the sixth transistor is connected to the OLED.

12. The pixel driving circuit according to claim 8, wherein the light-emitting drive module comprises a first transistor, a fifth transistor and a sixth transistor;
a gate electrode of the first transistor is connected to the first node, a first electrode of the first transistor is connected to a second node, the power line is connected to the second node, and a second electrode of the first transistor is connected to the third node;
a gate electrode of the fifth transistor is connected to the enable signal line to receive the enable signal; a first electrode of the fifth transistor is connected to the second node; and a second electrode of the fifth transistor is connected to the first terminal of the capacitor;
a gate electrode of the sixth transistor is connected to the enable signal line to receive the enable signal; a first electrode of the sixth transistor is connected to the third node; and
a second electrode of the sixth transistor is connected to the OLED.

13. The pixel driving circuit according to claim 11, wherein the first transistor is configured to be terminated in the reset stage; the first transistor is configured to be conducted in the threshold voltage compensate stage; and the first transistor is configured to be conducted in the light-emitting drive stage;
the fifth transistor and the sixth transistor are configured to be terminated in the reset stage; the fifth transistor and the sixth transistor are configured to be terminated in the threshold voltage compensate stage; and the fifth transistor and the sixth transistor are configured to be conducted in the light-emitting drive stage.

14. The pixel driving circuit according to claim 12, wherein the first transistor is configured to be terminated in the reset stage; the first transistor is configured to be conducted in the threshold voltage compensate stage; and the first transistor is configured to be conducted in the light-emitting drive stage;
the fifth transistor and the sixth transistor are configured to be terminated in the reset stage; the fifth transistor and the sixth transistor are configured to be terminated in the threshold voltage compensate stage; and the fifth transistor and the sixth transistor are configured to be conducted in the light-emitting drive stage.

15. The pixel driving circuit according to claim 11, wherein each of the first to sixth transistors is p channel transistor.

16. The pixel driving circuit according to claim 12, wherein each of the first to sixth transistors is p channel transistor.

17. An organic light-emitting diode display apparatus comprising a pixel driving circuit of claim 1.
